(19) United States
(12) Patent Application Publication
(10) Pub. No.: US 2009/0213173 A1
(43) Pub. Date: Aug. 27, 2009

(54) LIQUID INJECTING APPARATUS

(75) Inventors: Norihiro MASUDA, Matsumoto-shi (JP); Toshio KUMAGAI, Shiojiri-shi (JP); Shinichi KAMOSHIDA, Shiojiri-shi (JP)

Correspondence Address: Workman Nydegger;1000 Eagle Gate Tower, 60 East South Temple, Salt Lake City, UT, 84111, US

(73) Assignee: Seiko Epson Corporation, Tokyo (JP)

(21) Appl. No.: 12/393,632

(22) Filed: Feb. 26, 2009

(30) Foreign Application Priority Data
Feb. 27, 2008 (JP) 2008-045614
Jan. 7, 2009 (JP) 2009-002004

(51) Int. Cl. B41J 2/165

(52) U.S. Cl. 347/33

(57) ABSTRACT

A liquid injecting apparatus includes an injection head for injecting liquid that is cured by irradiation of an energy ray to a target, an irradiation unit that solidifies the liquid injected to the target by irradiating the energy ray, and a removal unit that removes the liquid adhering to a light emitting part of the irradiation unit.

### CROSS-REFERENCE TO RELATED APPLICATION

The entire disclosure of Japanese Patent Application No. 2008-045614 (filed Feb. 27, 2008) and Japanese Patent Application No. 2009-002004 (filed Jan. 7, 2009) are expressly incorporated by reference herein.

### BACKGROUND

1. Technical Field

The present invention relates to a liquid injecting apparatus that injects energy ray-curable liquid such as energy ray curable-type ink that is cured by irradiation of an energy ray such as an ultraviolet (UV) ray, and more particularly, to a liquid injecting apparatus such as an ink jet recording apparatus that forms dots on a recording medium by injecting ink droplets from a nozzle in accordance with print data mainly.

2. Related Art

As liquid injecting apparatuses that injects liquid to a target, ink jet recording apparatuses that perform a printing operation by injecting ink onto a recording sheet have been known. A record head of the ink jet recording apparatus performs a printing operation by discharging ink, which is pressed by a pressure generating chamber, from a nozzle to a recording sheet as ink droplets. Accordingly, there is a problem that the record head may be in a state, in which defective discharge is performed due to an increase in the viscosity of ink, which is caused by evaporation of a solvent from a nozzle opening, solidification of ink adhering to near the nozzle, or the like and generate defective printing of the ink jet recording apparatus. Thus, in the ink jet recording apparatus, a cleaning operation for a nozzle forming face by wiping the nozzle forming face is performed for maintaining discharge characteristics.

As the ink jet recording apparatus, in JP-A-10-175292, an ink jet recording apparatus including a rotary drum that can hold a printing medium on an outer circumferential face thereof and a record head that is disposed near the rotary drum and discharges ink toward a printing medium that is held on the outer circumferential face and having a wiping member, which removes ink adhering to a nozzle forming face by being brought into contact with the nozzle forming face of the record head in accordance with rotation of the rotary drum, installed on the outer circumferential face of the rotary drum has been disclosed.

On the other hand, as one type of an ink jet recording method, there is a UV ink jet type. This UV ink jet type is a recording type in which a printing operation is performed by curing energy ray-curable ink by adhering the energy ray-curable ink, which can be cured by irradiation of an energy ray such as a ultraviolet (UV) ray, to a recording medium and then, irradiating the energy ray to the recording medium.

However, in the recording apparatus using energy ray-curable ink, the ink is cured by receiving an energy ray such as an ultraviolet ray. Thus, when small ink droplets floating inside the apparatus adhere to an irradiation lamp of the energy ray, the ink droplets are cured. Accordingly, when the apparatus is used in such a state for a long time, the irradiation efficiency decreases, and there is a problem that solidification of the ink injected to the recording medium may not be performed assuredly. In addition, when a spot is formed with the ink adhering to the irradiation lamp, a dry spot of ink injected onto the recording medium is generated, and there is a problem that defective image formation may occur.

### SUMMARY

An advantage of some aspects of the invention is that it provides a liquid injecting apparatus capable of stably irradiating light for a long time.

According to a first aspect of the invention, there is provided a liquid injecting apparatus including: an injection head for injecting liquid that is cured by irradiation of an energy ray to a target; an irradiation unit that solidifies the liquid injected to the target by irradiating the energy ray; and a removal unit that removes the liquid adhering to a light emitting part of the irradiation unit.

According to the above-described liquid injecting apparatus, the removal unit that removes the liquid adhering to the light emitting part of the irradiation unit is included. Accordingly, the irradiation efficiency of the irradiation unit does not decrease. In addition, the liquid injected onto the recording medium can be solidified assuredly, and accordingly, defective image formation due to uneven curing of the liquid can be prevented assuredly.

In the above-described liquid injecting apparatus, the removal unit may be configured as a blade for removing the liquid adhering to the light emitting part by being brought into contact with the light emitting part of the irradiation unit. In such a case, the liquid adhering to the light emitting part of the irradiation unit can be assuredly removed by using a simple mechanism.

The above-described liquid injecting apparatus may further include a rotary drum that holds a recording medium on an outer circumferential face thereof and rotates about a shaft center. In the case, the light emitting part of the irradiation unit is disposed along the outer circumferential face of the rotary drum, and a blade is disposed between end parts of the recording medium that is held by the rotary drum. In such a case, since the blade removes the adhering liquid by being brought into contact with the light emitting part by rotation of the rotary drum that holds the recording medium, the liquid adhering to the light emitting part can be assuredly removed without preparing a complicated mechanism or a special control process.

In the above-described liquid injecting apparatus, it may be configured that the injection head and the light emitting part of the irradiation unit are disposed along the outer circumferential face of the rotary drum, a protrusion height of the blade is changeable, and the protrusion height of the blade is changed such that the blade removes the liquid adhering to the light emitting part by being brought into contact with the light emitting part of the irradiation unit, and the blade and the injection head are not brought into contact with each other. In such a case, a wiping operation can be performed assuredly, and a clearance between the injection head and the recording medium can be decreased, whereby the image quality can be improved.

In the above-described liquid injecting apparatus, it may be configured that a transparent resin layer is formed on a light emitting face of the irradiation unit in advance, and the blade removes the liquid adhering to the surface of the resin layer by being brought into contact with the surface of the resin layer. In such a case, since the blade is brought into contact with the resin layer, a damage of the irradiation unit due to contact with the blade and a decrease in the irradiation efficiency due to the damage can be prevented.

In the above-described liquid injecting apparatus, the blade may be configured by dispersing fine particles that are harder than a resin forming the resin layer into an elastic material. In such a case, the adhering liquid is assuredly removed by scraping the resin layer through contact with the blade, and accordingly, the adhering liquid can be removed assuredly, and the light emitting part can be cleaned assuredly. Therefore, the light irradiation efficiency can be maintained.

In the above-described liquid injecting apparatus, liquid may be configured to be supplied to the blade before the blade is brought into contact with the irradiation unit. In such a case, the contact friction resistance between the blade and the irradiation unit can be decreased by using the liquid, and accordingly, the adhering liquid can be removed uniformly without any bias.

In the above-described liquid injecting apparatus, the liquid may be configured to be supplied to the blade by rotation of the rotary drum. In such a case, the liquid is supplied to the blade by rotating the rotary drum that holds the recording medium, and accordingly the liquid can be supplied to the blade assuredly without preparing a complicated mechanism or a special control process.

In the above-described liquid injecting apparatus, the liquid may be silicon-based oil. In such a case, an oil layer is formed by attaching the silicon-based oil to the light emitting part, and accordingly, the liquid adhering thereto can be removed for each oil layer. Therefore, the adhering liquid can be removed assuredly. In addition, by aggressively attaching the floating liquid to the oil layer, the attached liquid can be removed effectively, and accordingly, a superior cleaning effect for the apparatus can be exhibited.

### BRIEF DESCRIPTION OF THE DRAWINGS

The invention will be described with reference to the accompanying drawings, wherein like numbers reference like elements.

FIG. 1 is a perspective view showing a schematic configuration of a recording apparatus according to an embodiment of the invention.

FIG. 2 is a cross-section view showing the configuration of a liquid injecting apparatus according to an embodiment of the invention.

FIG. 3 is an enlarged cross-section view of major parts of the liquid injecting apparatus.

FIG. 4 is a diagram showing a second embodiment of the invention.

FIGS. 5A to 5C are diagrams showing a first modified example of the second embodiment.

FIGS. 6A and 6B are diagrams showing a second modified example of the second embodiment.

FIGS. 7A and 7B are diagrams showing a third modified example of the second embodiment.

FIG. 8 is a diagram showing a fourth modified example of the second embodiment.

### DESCRIPTION OF EXEMPLARY EMBODIMENTS

Next, embodiments of the invention will be described in detail.

Hereinafter, an ink jet recording apparatus as a liquid injecting apparatus according to an embodiment of the invention will be described with reference to the accompanying drawings.

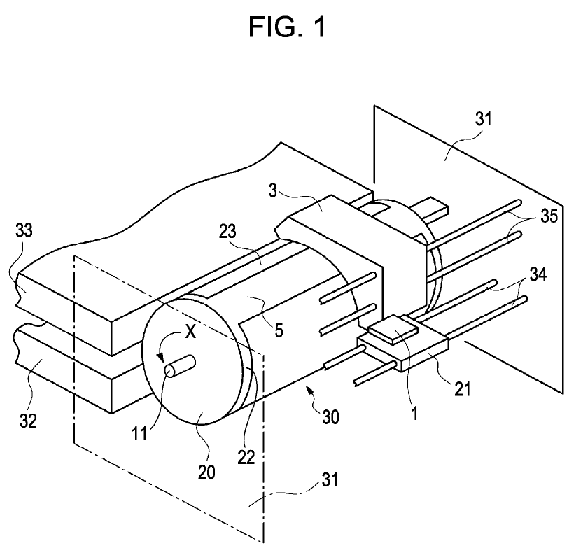

FIG. 1 shows the configuration of major parts of an ink jet recording apparatus as a liquid injecting apparatus according to an embodiment of the invention.

This example is an ink jet recording apparatus including a rotary drum 20 that supports a recording sheet 23 as a recording medium on the outer circumferential face 22 thereof as a support face and rotates about a shaft center, an injection head 1 that is mounted on a carriage 21 reciprocating in a direction perpendicular to the rotation direction of the rotary drum 20 along the outer circumferential face 22 and injects an energy ray-curable liquid from a nozzle toward the recording sheet 23 that is supported on the outer circumferential face 22, and an irradiation unit 3 that irradiates an energy ray for the an energy ray-curable liquid injected from the injection head 1 so as to adhere to the recording sheet 23.

Described in more details, in the ink jet recording apparatus, a record unit 30 is disposed between one pair of frames 31 that are erected to face each other, a recording sheet 23 is fed from a paper feed unit 32 to the record unit 30 so as to be recorded, and the recording sheet 23 for which the recording process is completed is discharged to a paper discharge unit 33.

The recording unit 30 is configured to include the rotary drum 20 that is supported between one pair of the frames 31 that are disposed parallel to each other, one pair of first guide shafts 34 and one pair of second guide shafts 34 that are the same as the first guide shafts 34, the carriage 21 that is guided by the first guide shafts 34 and reciprocates along the rotary drum 20, the injection head 1 that is mounted on the carriage 21, and the irradiation unit 3 that is guided by the second guide shafts 35 and reciprocates along the rotary drum 20.

The injection head 1 that is mounted on the carriage 21 discharges ink to adhere to the recording sheet 23 that rotates in a state that the recording sheet 23 is supported by the rotary drum 20. In this example, an energy ray-curable liquid such as an energy ray-curable ink that is cured by irradiation of an energy ray represented by light such as ultraviolet (UV) is used as the above-described ink. For example, the energy ray-curable liquid is ultraviolet-curable ink. In particular, the ultraviolet-curable ink, for example, is formed of components such as an ultraviolet-curable resin, a pigment, additives for performing a stable printing process by ink jet, and water.

Then, by rotating the rotary drum 20 in the direction of an arrow shown in the figure while the ultraviolet-curable ink is injected to the recording sheet 23, an ultraviolet ray is irradiated from the irradiation unit 3 to the ultraviolet-curable ink that adheres to the recording sheet 23. Accordingly, an image that is formed by the ultraviolet-curable ink is fixed to the surface of the recording sheet 23.

Then, when an image is recorded in a partial area of the paper sheet 23 in the longitudinal direction of the rotary drum 20 by rotating the rotary drum 20 one or more times, the carriage 21 moves along the first guide shaft 34 and performs a same recording operation for an area adjacent to the above-described area. Thereafter, the image can be formed on the entire surface of the recording sheet 23 by repeating the operation for moving the carriage 21 for every one rotation or more of the rotary drum 20 with the injection head 1 performing the recording operation.

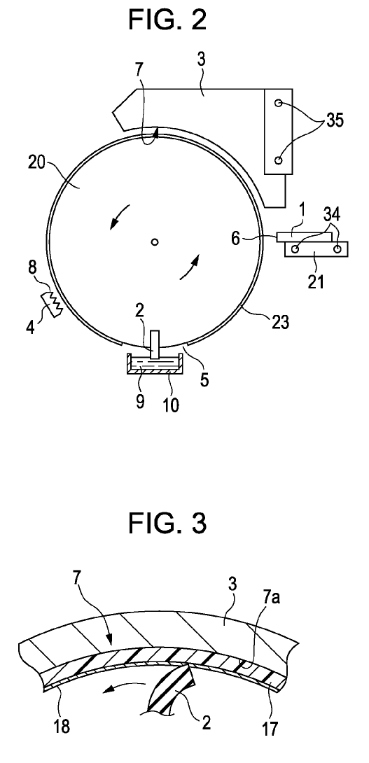

FIG. 2 is a cross-section view showing major parts of the liquid injecting apparatus according to this embodiment.

This liquid injecting apparatus includes an injection head 1 that injects ink as liquid to be cured by irradiation of an energy ray onto a recording sheet 23 as a target, an irradiation unit 3 as an irradiation unit that solidifies the ink injected onto the recording sheet 23 by irradiating an energy ray, a blade 2 as a removal unit that removes ink adhering to a light emitting part 7 of the irradiation unit 3, and a scraping member 4 that removes solidified liquid or the like adhering to the blade 2 after the removal operation.

In this example, the injection head 1, the irradiation unit 3, and the scraping member 4 are sequentially disposed in the rotation direction of the rotary drum 20 so as to follow the outer circumferential face 22 of the rotary drum 20. In addition, the light emitting part 7 of the irradiation unit 3 is formed to be disposed on a concave curve so as to follow the outer circumferential face 22 of the rotary drum 20 and face the outer circumferential face 22 with a predetermined clearance maintained.

The blade 2 is disposed between end parts (hereinafter, referred to as an inter-paper area 5) of the recording sheet 23 that is held so as to be wound around the outer circumferential face 22 of the rotary drum 20. The blade 2 is acquired by forming an elastic material such as rubber, elastomer, or polyurethane in a blade shape. In addition, the blade 2 is disposed so as to protrude in an approximate radial pattern from the outer circumferential face 22 of the rotary drum 20. The blade 2 is configured to be brought into contact and rubbed with the light emitting part 7 of the irradiation unit 3 that faces the blade 2 along the outer circumferential face 22 of the rotary drum 20 and remove the ink adhering to the light emitting part 7 by rotating the rotary drum 20.

In addition, a clearance between the injection head 1 and the rotary drum 20 is set to be larger than the clearance between the rotary drum 20 and the light emitting part 7 of the irradiation unit 3. Accordingly, the front end of the blade 2 and the injection head 1 are configured not to be engaged with each other.

FIG. 3 is an enlarged cross-section view of major parts showing a state in which the light emitting part 7 of the irradiation unit 3 is cleaned.

As described above, the light emitting part 7 of the irradiation unit 3 has a light emitting face 7a on which a transparent resin layer 17 is formed in advance. Accordingly, the blade 2 is brought into contact with and rubbed with the surface of the resin layer 17 so as to remove the ink adhering to the surface of the resin layer 17.

Here, it is preferable that the blade 2 configured by dispersing fine particles that are harder than the resin forming the resin layer 17 in an elastic material such as rubber, elastomer, or polyurethane described above is used. As the disperse particles, for example, reinforced dispersed particles such as metal particles or ceramic particles can be used. On the other hand, as a resin that forms the resin layer 17, for example, a resin material such as an acrylic resin or a PET resin can be used. Thus, it is preferable that the resin layer 17 is formed of only the resin without dispersing the above-described reinforced dispersed particles therein. In such a case, when the adhering ink is removed by scraping the surface of the resin layer 17 by using the blade 2, the surface layer of the resin layer 17 is slightly cut. Accordingly, the ink can be removed assuredly, and thereby any remaining after the removal operation is not generated. In addition, since any dispersed particle is not contained in the resin layer 17, the transparency is not blocked.

The scraping member 4 is configured to scrape out the solidified liquid by bringing the front end part of the blade 2 into contact with the scraping member 4 at a time when the blade 2 moves along the circumferential direction of the drum by rotation of the rotary drum 20. In this example, a concavo-convex face 8 is formed in a part of the scraping member 4 that faces the outer circumferential face 22 of the rotary drum 20 so as to be brought into contact with the blade 2 that moves along the outer circumferential face 22 by rotating the rotary drum 20. Accordingly, the solidified ink is scraped down.

In addition, in this apparatus, a container 10 in which liquid 9 is stored is disposed between the scraping member 4 and the injection head 1. Thus, when the blade 2 passes a position for facing the container 10 by rotation of the rotary drum 20, the solidified ink is scraped down by the scraping member 4, and the liquid 9 is supplied to the blade 2 before contact with the irradiation unit 3. Accordingly, the surface of the resin layer 17 is scraped by the blade 2 that is wet with the supplied liquid 9, and therefore, the contact friction resistance decreases. In addition, the surface of the resin layer 17 is covered with a liquid film 18, and accordingly, ink adhering thereon can be removed in an easy manner. As the liquid 9, it is preferable that silicon-based oil is used.

Under such a configuration, in a case where ultraviolet-curable ink is injected and recorded onto the recording sheet 23 from the injection head 1 with the rotary drum 20 rotating, when the inter-paper area 5 of the recording sheet 23 passes through an area that faces the light emitting part 7 of the irradiation unit 3, the blade 2 is brought into contact with and rubbed with the light emitting part 7. Accordingly, the ink adhering to the surface of the light emitting part 7 is removed. When the rotary drum 20 rotates further, the blade 2 is detached from the irradiation unit 3 and is brought into contact with the concavo-convex face 8 of the scraping member 4, and thereby ink is scraped down. When the rotary drum 20 rotates still further, the blade 2 is brought into contact with the liquid 9 inside the container 10. Accordingly, the liquid 9 is supplied, and the process proceeds to the next wiping operation. Thereafter, a cleaning operation for the irradiation unit 3 is performed on a regular basis.

As described above, in the liquid injecting apparatus according to this embodiment, the blade 2 is included as a removal unit that removes ink adhering to the light emitting part 7 of the irradiation unit 3. Accordingly, solidification of the ink injected onto the recording sheet 23 can be performed assuredly without decreasing the irradiation efficiency of the irradiation unit 3. Therefore, defective image formation due to uneven curing of the ink can be prevented assuredly.

In addition, the removal unit is the blade 2 that removes the ink adhering to the light emitting part 7 by being brought into contact with the light emitting part 7 of the irradiation unit 3. Accordingly, the ink adhering to the light emitting part 7 of the irradiation unit 3 can be assuredly removed by using a simple mechanism.

In addition, the rotary drum 20 that rotates about the shaft center with a recording sheet 23 maintained on the outer circumferential face 22 thereof is further included, the light emitting part 7 of the irradiation unit 3 is disposed along the outer circumferential face 22 of the rotary drum 20, and the blade 2 is disposed in the inter-paper area 5 between the end parts of the recording sheet 23 that is held by the rotary drum 20. Accordingly, the blade 2 is brought into contact with the light emitting part 7 so as to remove the adhering ink by rotating the rotary drum 20 that holds the recording sheet 23. Therefore, the ink adhering to the light emitting part 7 can be removed assuredly without preparing a complicated mechanism or a special control process.

In addition, the transparent resin layer is formed in advance on the light emitting face of the irradiation unit 3. Thus, when the blade 2 removes the liquid 9 adhering to the surface of the resin layer 17 by being brought into contact with the surface of the resin layer 17, the blade 2 is brought into contact with the resin layer 17 only. Accordingly, damage of the irradiation unit 3 due to contact with the blade 2 and a decrease in the irradiation efficiency due to the damage can be prevented.

In addition, since the blade 2 is configured by dispersing fine particles harder than the resin that forms the resin layer 17 into the elastic material, the blade 2 removes the adhering ink by scraping the resin layer 17 by being brought into contact with the resin layer 17. Accordingly, it is possible to remove the adhering ink assuredly and clean the light emitting part 7 assuredly. Therefore, the light irradiation efficiency can be maintained.

In addition, the liquid 9 is supplied to the blade 2 before the blade 2 is brought into contact with the irradiation unit 3. Accordingly, the contact friction resistance between the blade 2 and the irradiation unit 3 can be decreased due to the liquid 9, and thereby the adhering ink can be removed uniformly without any bias.

In addition, the liquid 9 is supplied to the blade 2 by rotating the rotary drum 20, and the liquid 9 is supplied to the blade 2 by rotating the rotary drum 20 that holds the recording sheet 23. Therefore, the liquid 9 can be supplied to the blade 2 assuredly without preparing a complicated mechanism or a special control process.

In addition, when the liquid 9 is silicon-based oil, the silicon-based oil is attached to the light emitting section 7 and forms an oil layer as the liquid film 18. Accordingly, ink adhering thereto can be removed for each oil layer, and therefore the adhering ink can be removed assuredly. In addition, by aggressively attaching floating ink to the oil layer, the adhering ink can be removed effectively, and thereby excellent cleaning effect for the apparatus is realized.

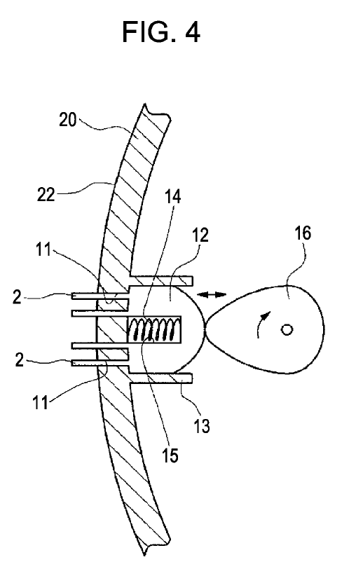

FIG. 4 is a cross-section view of major parts showing a second embodiment of the invention.

According to this embodiment, the protrusion height of the blade 2 can be changed, and the blade 2 is configured to be able to move forward or backward with respect to the outer circumferential face 22 of the rotary drum 20. In addition, also in the second embodiment, the injection head 1 and the light emitting part 7 of the irradiation unit 3 are disposed along the outer circumferential face 22 of the rotary drum 20.

In this example, a plurality of (in the example shown in the figure, four) the blades 2 is disposed. In addition, the rotary drum 20 is formed in a center-hollow shape, and a plurality of through holes 11 having a slit shape through which the blades 2 are inserted and pass the peripheral wall is formed. According to this example, the plurality of the blades 2 is formed to protrude from a base material part 12. Accordingly, the blades 2 pass through the through holes 11 from the rear side of the peripheral wall of the rotary drum 20.

The base material part 12 is held to be slidable by a holding part 13 and can be pressed by a cam member 16 from the rear side. In addition, inside a storage space 15 located inside the base material part 12, a biasing member 14 such as a spring is housed so as to bias the base material part 12 toward the cam member 16 in a pressing manner. Accordingly, by driving the cam member 16 to rotate by a driving unit not shown in the figure, the base material part 12 moves forward or backward with respect to the peripheral wall of the rotary drum 20. Thereby, the protrusion height of the blade 2 from the outer circumferential face 22 can be changed, and the blade 2 is configured to be movable forward or backward with respect to the outer circumferential face 22 of the rotary drum 20.

According to this embodiment, by configuring the protrusion height of the blade 2 from the outer circumferential face 22 to be changeable, the irradiation unit 3 and the blade 2 are engaged with each other, and the blade 2 and the injection head 1 are not engaged with each other. In other words, according to this embodiment, the protrusion height of the blade 2 is changed such that the blade 2 is brought into contact with the light emitting part 7 of the irradiation unit 3 so as to remove the ink adhering to the light emitting part 7 and the blade 7 is not brought into contact with the injection head 1. Accordingly, by configuring the protrusion height of the blade 2 to be changeable, sufficient cleaning for the irradiation unit 3 is realized, and the clearance between the injection head 1 and a recording sheet 23 is decreased. Therefore, the image quality can be improved.

Other configurations are the same as those of the above-described embodiment. Thus, to each same part, a same reference sign is assigned. Also in this embodiment, the same advantages as those of the above-described embodiment are acquired. In addition, the configuration for changing the protrusion height of the blade 2 is not limited to the configuration shown in FIG. 4, and a different configuration may be used. Hereinafter, modified examples of the configuration for changing the protrusion height will be described.

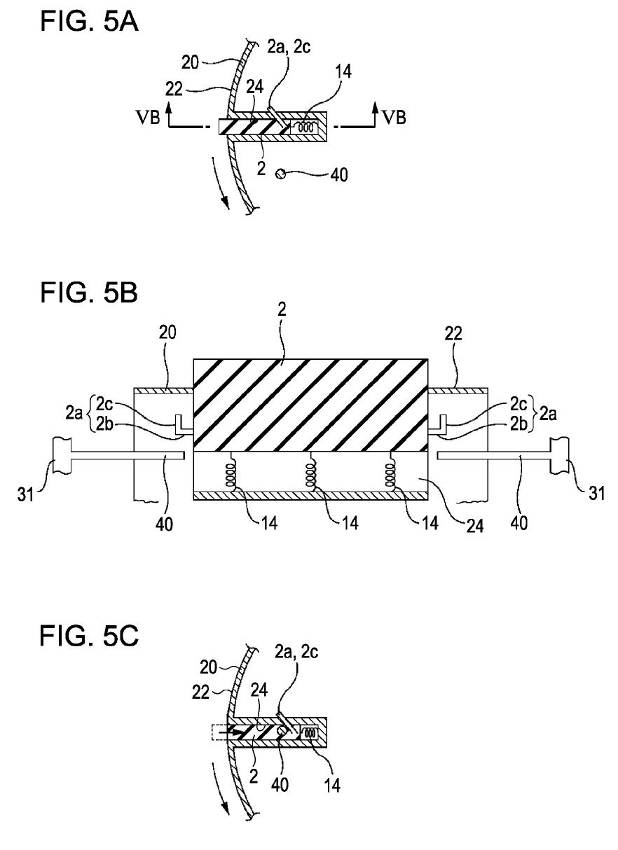

FIGS. 5A to 5C are diagrams showing a first modified example of the second embodiment. FIG. 5B is a cross-section view taken along line VB-VB shown in FIG. 5A.

In this example, the rotary drum 20 is formed to have a hollow center, and side ends of the rotary drum 20 are open. In addition, in the outer peripheral wall of the rotary drum 20, a depressed area 24 into which the blade 2 is intruded is formed. Into this depressed area 24, the blade 2 is intruded to be slidable. In addition, on the bottom of the depressed area 24, a biasing member 14 such as a spring that biases the blade 2 to the outer side in the diameter direction of the rotary drum 20 is seated.

In addition, side ends of the depressed area 24 are open, and “L”-shaped parts 2a that are formed in an approximate letter “L” are disposed on sides thereof (see FIG. 5B). This “L”-shaped parts 2a are installed to both side ends of the bottom part of the blade 2. When the rotary drum 20 rotates, the “L”-shaped parts 2a rotate integrally with the blade 2. The “L”-shaped part 2a is formed of a pull-out part 2b that overhangs to the outer side in the shaft direction of the rotary drum 20 and a crossing part 2c that intersects the pull-out part 2b (see FIG. 5B). In addition, the crossing part 2c is tilted such that the upper end side (the outer side in the diameter direction of the rotary drum 20) of the crossing part 2c is fallen down in a direction opposite to the rotation direction of the rotary drum 20 (see FIG. 5A).

In addition, pressing parts 40 that extend toward both ends in the shaft direction of the rotary drum 20 are fixed to the main body of the printer, and the front end parts of the pressing parts 40 are put into the inside of the rotary drum 20 from both ends in the shaft direction of the rotary drum 20 as open ends. Here, the main body of the printer is a part (for example, a frame 31) of the printer other than the rotary drum 20. In other words, the rotary drum 20 rotates relative to the pressing parts 40. By relatively rotating the rotary drum 20, the pressing parts 40 are engaged with the crossing parts 2c. In addition, during rotation of the rotary drum 20, the pressing parts 40 are engaged only with the crossing parts 2c, and the pressing parts 40 are not engaged with other members located inside the rotary drum 20.

Then, when the rotary drum 20 rotates further in a state, in which the pressing parts 40 and the crossing parts 2c are engaged with each other, the pressing parts 40 press the blade 2 to the inner side in the diameter direction of the rotary drum 20 through the “L”-shaped parts 2a. Accordingly, the blade 2 is moved backward to the inner side in the diameter direction of the rotary drum 20. As a result, as shown in FIG. 5C, the front end of the blade 2 is positioned to the inner side relative to the outer circumferential face 22 of the rotary drum 20.

As described above, in this modified example, when the blade 2 reaches a position for facing the light emitting part 7 of the irradiation unit 3 during rotation of the rotary drum 20, the blade 2 is biased by the biasing member 14 so as to be brought into contact with the light emitting part 7 with a sufficient protrusion height. On the other hand, when the blade 2 reaches a position for facing the nozzle forming face 6 of the injection head 1, the pressing parts 40 press the blade 2 in resistance against biasing of the biasing members 14, and the protrusion height becomes a height for departing the front end of the blade 2 from the nozzle forming face 6. Then, the protrusion height is maintained while the blade 2 faces the nozzle forming face 6.

As described above, in this modified example, the protrusion height of the blade 2 is changed by using rotation of the rotary drum 20. Thus, the protrusion height of the blade 2 is changed such that the blade 2 is brought into contact with the light emitting part 7 of the irradiation unit 3 so as to remove the ink adhering to the light emitting part 7 and the blade 2 and the injection head 1 are not brought into contact with each other. Under such a configuration, a driving mechanism (for example, a driving mechanism for rotating the cam member 16 shown in FIG. 4) for changing the protrusion height is not needed to be disposed additionally. Thus, the above-described configuration is more preferable than the configuration shown in FIG. 4.

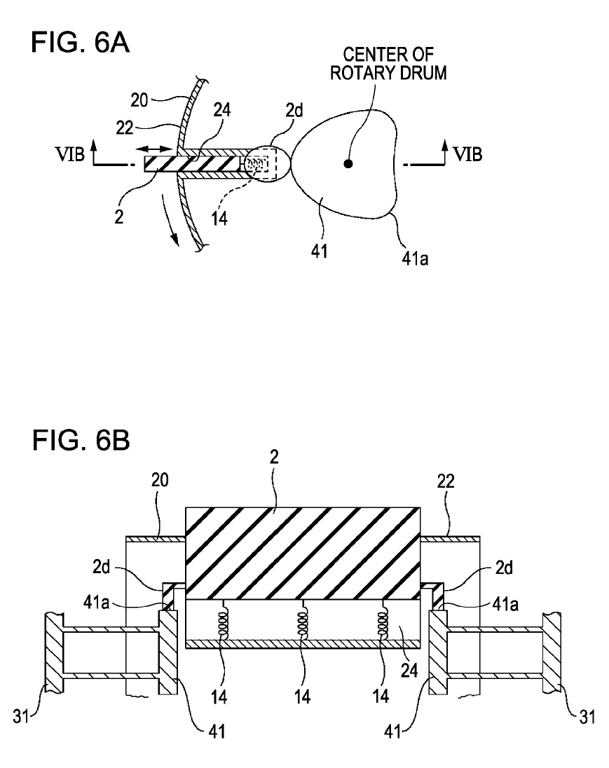

FIGS. 6A and 6B are diagrams showing a second modified example of the second embodiment. FIG. 6B is a cross-section view taken along line VIB-VIB shown in FIG. 6A.

In this example, a cam 41 having an approximately heart shape is contained inside the rotary drum 20, and a contact 2d that is brought into contact with a cam face 41a of the cam 41 to be slid on the cam face 41a is attached to the blade 2. The cam 41 is fixed to the main body (in particular, a frame 31) of the printer such that the center of the cam 41 coincides with the rotation center of the rotary drum 20. Accordingly, the rotary drum 20 rotates relative to the cam 41. In addition, the blade 2 is biased by the biasing member 14 such that contact between the contact 2d and the cam face 41a is maintained.

Then, when the rotary drum 20 rotates relative to the cam 41, the blade 2 and the contact 2d rotate relative to the cam 41, as well. At this moment, since the contact 2d is slid on the cam face 41a, the blade 2 moves forward or backward with respect to the peripheral wall of the rotary drum 20, and thereby the protrusion height of the blade 2 changes. As described above, also in this modified example, the protrusion height of the blade 2 is changed by using rotation of the rotary drum 20, the blade 2 is brought into contact with the light emitting part 7 of the irradiation unit 3 so as to remove the ink adhering to the light emitting part 7, and the protrusion height of the blade 2 is changed such that the blade 2 and the injection head 1 are not brought into contact with each other.

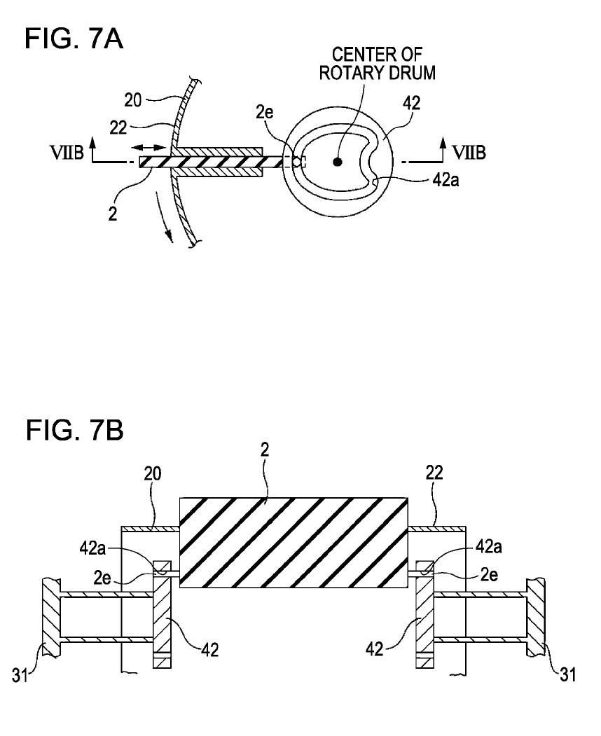

FIGS. 7A and 7B are diagrams showing a third modified example of the second embodiment. FIG. 7B is a cross-section view taken along line VIIB-VIIB shown in FIG. 7A.

In this example, a groove cam 42 that has a same function as that of the above-described cam 41 is contained inside the rotary drum 20, and an engagement protrusion 2e that is engaged with a groove 42a formed in the groove cam 42 so as to move along the groove 42a is attached to the blade 2. Since the groove cam 42, like the above-described cam 41, is fixed to the main body of the printer such that the center of the groove cam 42 coincides with the center of the rotary drum 20, the rotary drum 20 rotates relative to the groove cam 42. Then, when the rotary drum 20 rotates relative to the groove cam 42, the engagement protrusion 2e moves along the groove 42a. Accordingly, the blade 2 moves in the diameter direction of the rotary drum 20, and thereby the protrusion height is changed. The other configurations are the same as those of the second modified example, and the same advantages as those of the second modified example are acquired.

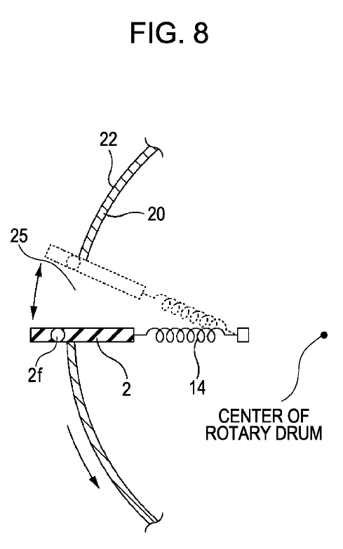

FIG. 8 is a diagram showing a fourth modified example of the third embodiment.

In this example, an opening 25 having a width that increases in the circumferential direction of the rotary drum 20 is formed on the outer peripheral wall of the rotary drum 20. The blade 2 protrudes from the inner side of the rotary drum 20 toward the outer side thereof through the opening 25. In addition, in a part of the blade 2 that is located on the outer side relative to the rotary drum 20, protrusions 2f that extend from both side ends (both ends in the shaft direction of the rotary drum 20) of the blade 2 toward the outer side in the shaft direction of the rotary drum 20 are formed.

In addition, the blade 2 is biased to the outer side in the diameter direction of the rotary drum 20 by the basing member 14. The blade 2 can be oscillated so as to be fallen down in a direction opposite to the rotation direction of the rotary drum 20 with a corner (hereinafter, referred to as an opposite-side corner) that is located on a side opposite to a side of the biasing member 14, which is fixed to the blade 2 of the basing member 14, used as a fulcrum point (see FIG. 8). In addition, the opposite-side corner of the biasing member 14 is positioned to be slightly eccentric to the blade 2 side from the rotation center of the rotary drum 20.

When the blade 2 faces the nozzle forming face 6 of the injection head 1 in accordance with rotation of the rotary drum 20, the protrusion 2f attached to the blade 2 is engaged with another pressing part (not shown) that is fixed to the main body (for example, a side of the injection head 1) of the printer. In such a state, when the rotary drum 20 rotates further, the pressing part presses the blade 2 such that the blade 2 is fallen down in a direction opposite to the rotation direction of the rotary drum 20. Accordingly, the blade 2 that is located in a normal position (a position denoted by a solid line shown in FIG. 8) in the rotation direction of the rotary drum 20 is oscillated up to a fallen position (a position denoted by a broken line shown in FIG. 8). The protrusion height at a time when the blade 2 is located in the fallen position becomes a height for which the front end of the blade 2 is departed from the nozzle forming face 6. The blade 2 is returned to the normal position until the blade 2 moves to the position for facing the light emitting part 7 of the irradiation unit 3 in accordance with rotation of the rotary drum 20. When located in the normal position, the blade 2 protrudes with a sufficient protrusion height, and accordingly, the front end of the blade 2 is brought into contact with the light emitting part 7 appropriately.

As described above, also in this modified example, the protrusion height of the blade 2 is changed by using rotation of the rotary drum 20. Thus, the protrusion height of the blade 2 is changed such that the blade 2 is brought into contact with the light emitting part 7 of the irradiation unit 3 so as to remove the ink adhering to the light emitting part 7, and the blade 2 and the injection head 1 are not brought into contact with each other.

In addition, in the above-described embodiment, the recording apparatus of a type that injects ink onto a recording sheet 23 held by the rotary drum 20 has been described as an example. However, the invention can be applied to a recording apparatus of a type that holds a recording sheet by using a platen and injects ink from an injection head that reciprocates along the platen.

In other words, a configuration in which an injection head and an irradiation unit are mounted on a carriage that reciprocates along a platen, a blade for cleaning the irradiation unit is disposed near a home position as a waiting place of the injection head, and the blade and the irradiation unit are brought into contact with each other by reciprocating the carriage may be used. The invention also includes such a form.

In addition, in the above-described embodiment, as the above-described irradiation unit, an LED that emits light of an ultraviolet band may be used. However, the irradiation unit is not limited thereto. Thus, as the irradiation unit, various energy ray irradiating units such as a metal halide lamp, a xenon lamp, a carbon-arc lamp, a chemical lamp, a low-pressure mercury lamp, or a high-pressure mercury lamp may be used.

In the above-described embodiments, the injection head 1 may be applied to a liquid injecting apparatus that uses a piezoelectric vibrator as a pressure generating element that is a drive element for injecting liquid. In addition, the injection head 1 may be applied to a liquid injecting apparatus that uses a heating element.

In addition, as a representative example of the liquid injecting apparatus, there is the above-described ink jet recording apparatus having an ink jet recording head that is used for recording an image. However, the invention may be applied to various liquid injecting apparatuses such as an apparatus having a coloring material injecting head that is used for manufacturing a color filter, for example, a liquid crystal display, an apparatus having an electrode material (conductive paste) injecting head that is used for forming an electrode of an organic EL display, a field emission display (FED), or the like, an apparatus having a bioorganic material injecting head that is used for manufacturing a bio chip, and an apparatus having a test material injecting head as a precision pipette, as other liquid injecting apparatuses.

What is claimed is:

1. A liquid injecting apparatus comprising:
an injection head for injecting liquid that is cured by irradiation of an energy ray to a target;
an irradiation unit that solidifies the liquid injected to the target by irradiating the energy ray; and
a removal unit that removes the liquid adhering to a light emitting part of the irradiation unit.

2. The liquid injecting apparatus according to claim 1, wherein the removal unit is a blade that removes the liquid adhering to the light emitting part by being brought into contact with the light emitting part of the irradiation unit.

3. The liquid injecting apparatus according to claim 2, further comprising:
a rotary drum that holds a recording medium on an outer circumferential face thereof and rotates about a shaft center,
wherein the light emitting part of the irradiation unit is disposed along the outer circumferential face of the rotary drum, and
wherein a blade is disposed between end parts of the recording medium that is held by the rotary drum.

4. The liquid injecting apparatus according to claim 3,
wherein the injection head and the light emitting part of the irradiation unit are disposed along the outer circumferential face of the rotary drum,
wherein a protrusion height of the blade is changeable; and
wherein the protrusion height of the blade is changed such that the blade removes the liquid adhering to the light emitting part by being brought into contact with the light emitting part of the irradiation unit, and the blade and the injection head are not brought into contact with each other.

5. The liquid injecting apparatus according to claim 2,
wherein a transparent resin layer is formed on a light emitting face of the irradiation unit in advance, and
wherein the blade removes the liquid adhering to the surface of the resin layer by being brought into contact with the surface of the resin layer.

6. The liquid injecting apparatus according to claim 5, wherein the blade is configured by dispersing fine particles that are harder than a resin forming the resin layer into an elastic material.

7. The liquid injecting apparatus according to claim 2, wherein liquid is supplied to the blade before the blade is brought into contact with the irradiation unit.

8. The liquid injecting apparatus according to claim 7, wherein the liquid is supplied to the blade by rotation of the rotary drum.

9. The liquid injecting apparatus according to claim 7, wherein the liquid is silicon-based oil.
